(19) United States
(12) Patent Application Publication
(10) Pub. No.: US 2006/0098793 A1
(43) Pub. Date: May 11, 2006

(54) Dynamic content delivery

(75) Inventors: George William Erhart, Pataskala, OH (US); Valentine C. Matula, Granville, OH (US); David Joseph Skiba, Golden, CO (US)

Correspondence Address: DEMONT & BREYER, LLC, SUITE 250, 100 COMMONS WAY, HOLMDEL, NJ, 07733, US

(73) Assignee: Avaya Technology Corp., Basking Ridge, NJ (US)

(21) Appl. No.: 10/983,558

(22) Filed: Nov. 8, 2004

(51) Int. Cl. H04M 11/00; H04M 3/00

(52) U.S. Cl. 379/88.16; 379/266.07

(57) ABSTRACT

A method and apparatus that enable the delivery of relevant content to a telecommunications user engaged in a call are disclosed. In the illustrative embodiment content is selected based on the state of the conversation, which is determined by any of the following: the interaction of a service agent or interactive voice response system with a software application; the menu state in an interactive voice response system; the current point in a script that is followed by the service agent; the current point in a workflow that is related to the call; information associated with the caller; and information associated with the call. Content might also be based on one or more of the following: the identity of the user, the telecommunications terminal employed by the user, the date and time, and the location of the user.

### FIELD OF THE INVENTION

The present invention relates to telecommunications in general, and, more particularly, to dynamic content delivery.

### BACKGROUND OF THE INVENTION

A call center is a place where calls from users, such as customers, are handled in support of an organization's activities. Organizations that provide a call center, such as companies that offer a service or a product, do so to provide assistance and information to customers of the service or product. A call center typically comprises an interactive voice response (IVR) system that enables a caller to obtain information without any human involvement, or to speak to a person known as a “service agent”. Typically an interactive voice response system presents a hierarchy of menus to a caller, and enables the caller to input information to navigate the menus (e.g., entering alphanumeric information via a telephone keypad, selecting a menu option by saying the number associated with the option, etc.).

FIG. 1 depicts telecommunications system 100 in accordance with the prior art. Telecommunications system 100 comprises telecommunications terminal 102, telecommunications network 103, and call center 104, interconnected as shown.

User 101 uses telecommunications terminal 102 (e.g., a telephone, a browser-enabled client, etc.) to place a call to call center 104 via telecommunications network 103 (e.g., the Public Switched Telephone Network [PSTN], the Internet, etc.). Typically user 101 uses telecommunications terminal 102 to place a voice telephone call to call center 104. In some instances, however, user 101 might initiate a text-based instant messaging (IM) session, or might activate a “push-to-talk” button on a website that is associated with call center 104, etc.

FIG. 2 depicts the salient elements of call center 104, in accordance with the prior art. Call center 104 comprises data-processing system 205; interactive voice response system (IVR) 206; telecommunications terminals 207-1 through 207-N, where N is a positive integer; clients 209-1 through 209-N; and application server 210, interconnected as shown.

As shown in FIG. 2, each telecommunications terminal 207-n (e.g., a telephone, etc.), for n=1 through N, is associated with a respective service agent 208-n. Service agent converses with the caller via telecommunications terminal 207, and, during the call, might submit one or more commands (e.g., looking up a billing record associated with the caller, etc.) to a software application via client 209-n (e.g., a personal computer, a “dumb” terminal, etc.)

Data-processing system 205 is one of a private branch exchange (PBX), a gateway, a router, etc. that receives incoming calls from telecommunications network 103 and directs the calls to interactive voice response (IVR) system 206 or to one of telecommunications terminals 207. Data-processing system 205 also receives outbound signals from telecommunications terminals 207 and interactive voice response system 206 and transmits the signals on to telecommunications network 103 for delivery to the caller's terminal.

Interactive voice response system 206 presents one or more menus to the caller and receives input from the caller (e.g., speech signals, keypad input, etc.) via data-processing system 205. Interactive voice response system 206 can submit commands and forward caller input to a software application that resides on application server 210, and can receive output from the software application.

Application server 210 hosts one or more software applications that perform tasks such as customer record maintenance, inventory management, order processing, etc. As described above, these software applications can be accessed by clients 209 and by interactive voice response system 206.

### SUMMARY OF THE INVENTION

In many situations, it would be advantageous if a telecommunications terminal user who is engaged in a conversation with a service agent were to automatically receive content (e.g., an image, dynamic video, audio, text, etc.) that is based on the state of the conversation. For example, while a telecommunications terminal user is engaged in a voice telephone call with a Lands' End® service agent to order a winter coat, a video advertisement for accessories such as hats and gloves might be transmitted to the user's terminal when the service agent accesses an inventory software application to check for colors and sizes that are in stock.

As another example, when a telecommunications terminal user calls a doctor's office to make an appointment for a physical and discuss an erroneous charge on a recent bill, the user might receive:

a video reminder to fast for 12 hours before the appointment while the service agent (i.e., the receptionist) consults the office scheduling software application and proposes alternative times and dates, and
a video that provides the “billing inquiry” telephone number for the user's health insurance company
   while the receptionist reviews the appropriate records via the office billing software application.

The present invention thus enables the delivery of relevant content to a telecommunications user engaged in a call. In particular, in the illustrative embodiment content is selected based on the state of the conversation, where the state of the conversation is determined by any of the following:
the interaction of a service agent or interactive voice response system with a software application
the current menu or menu navigation history in an interactive voice response system
the current point in a script that is followed by the service agent
the current point in a workflow (i.e., a sequence of tasks performed by persons, or software applications, or both, in an organization to complete a procedure) that is related to the call
information associated with the caller (e.g., the caller's age, a prior transaction of the caller, etc.)
information associated with the call (e.g., the location of the caller, the date and time of the call, data input by the user during the call, etc.)

In addition, in the illustrative embodiment content that is delivered to a user might also be based on one or more of the following: the identity of the caller; the telecommunications terminal used by the caller; the location of the caller; and the date and time. The following examples illustrate the utility of delivering content that is based on these additional factors:
When a user calls the Hertz call center for a rental car, the user might receive an advertisement for a special rate on a Corvette® if the user rented a premium car on a previous trip.
When a user calls a call center using a third-generation CDMA (Code Division Multiple Access) cellular phone, the user might receive a high-bandwidth version of a video.
When a user calls a call center for Sports Illustrated® magazine, the user might receive an advertisement for an upcoming baseball game in the city from which the user is calling.
When a user in New York City calls a call center for The Food Channel® cable television channel, the user might receive an advertisement for Ray's Pizza when the time is between noon and 2 pm and an advertisement for Joe's Pancake House when the time is between 7 am and 11 am.

In the illustrative embodiment, content is transmitted to the telecommunications terminal user such that the mode of communication of the content is complementary to the mode of communication of the call (e.g., the mode of communication of the content is different than the mode of communication of the call, the mode of communication of the content is non-disruptive to the user, etc.). For example, a user engaged in a voice call might receive video content during the call; a user engaged in an instant messaging session might receive audio content, or video content in a separate window, or both; and so forth.

The illustrative embodiment comprises: transmitting a signal to a first telecommunications terminal associated with a first user; wherein the first user is engaged in a conversation with a second user of a second telecommunications terminal; and wherein the signal is based on the current state of the conversation; and wherein the mode of communication represented by the signal is different than the mode of communication of the conversation.

### BRIEF DESCRIPTION OF THE DRAWINGS

FIG. 1 depicts telecommunications system 100 in accordance with the prior art.

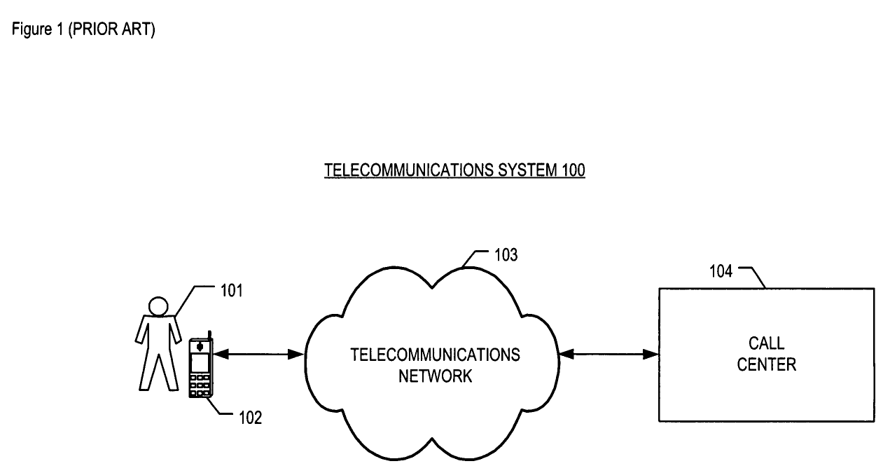

FIG. 2 depicts a block diagram of the salient elements of call center 104, as shown in FIG. 2, in accordance with the prior art.

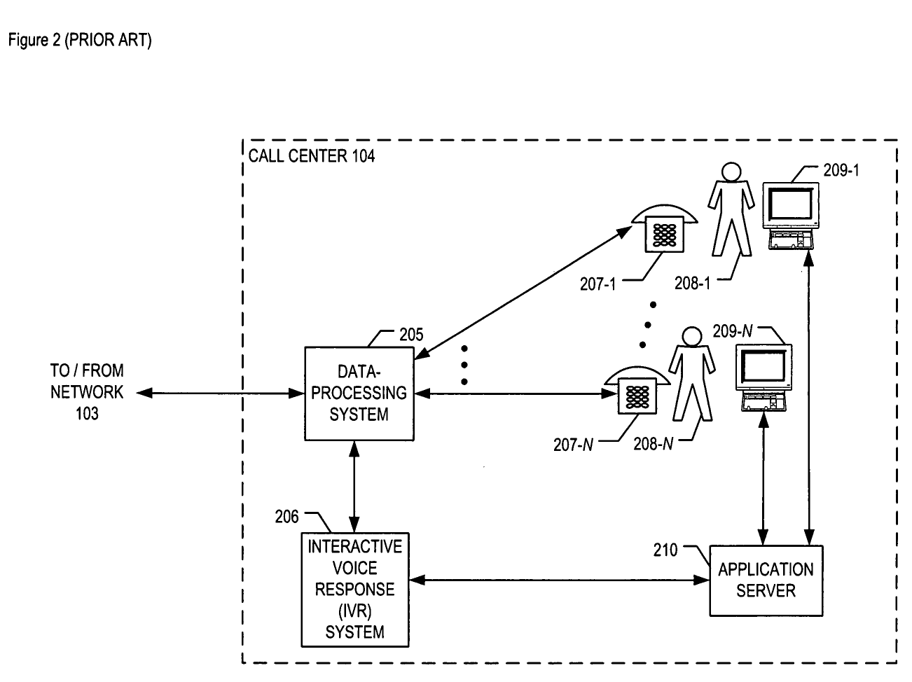

FIG. 3 depicts the salient elements of call center 304, in accordance with the illustrative embodiment of the present invention.

FIG. 4 depicts a block diagram of the salient components of application server 310, as shown in FIG. 3, in accordance with the illustrative embodiment of the present invention.

FIG. 5 depicts a flowchart of the salient tasks of application server 310 when an incoming call is handled by a service agent, in accordance with the illustrative embodiment of the present invention.

FIG. 6 depicts a flowchart of the salient tasks of application server 310 when an incoming call is handled by interactive voice response system 306, as shown in FIG. 3, in accordance with the illustrative embodiment of the present invention.

### DETAILED DESCRIPTION

The terms appearing below are given the following definitions for use in this Description and the appended Claims.

For the purposes of the specification and claims, the term “call” is defined as an interactive communication involving one or more telecommunications terminal users. A call might be a traditional voice telephone call, an instant messaging (IM) session, a video conference, etc.

For the purposes of the specification and claims, a signal that is “non-disruptive” to a telecommunications user engaged in a call is defined as a signal that the user is able to perceive and comprehend while simultaneously engaging in conversation.

For the purposes of the specification and claims, the term “calendrical time” is defined as indicative of one or more of the following:
(i) a time (e.g., 16:23:58, etc.),
(ii) one or more temporal designations (e.g., Tuesday, November, etc.),
(iii) one or more events (e.g., Thanksgiving, John's birthday, etc.), and
(iv) a time span (e.g., 8:00 PM to 9:00 PM, etc.).

For the purposes of the specification and claims, the term “script” is defined as a list of one or more tasks to be performed by a service agent during a call with a customer.

For the purposes of the specification and claims, the term “workflow” is defined as a sequence of tasks performed by persons, or software applications, or both, to complete a procedure.

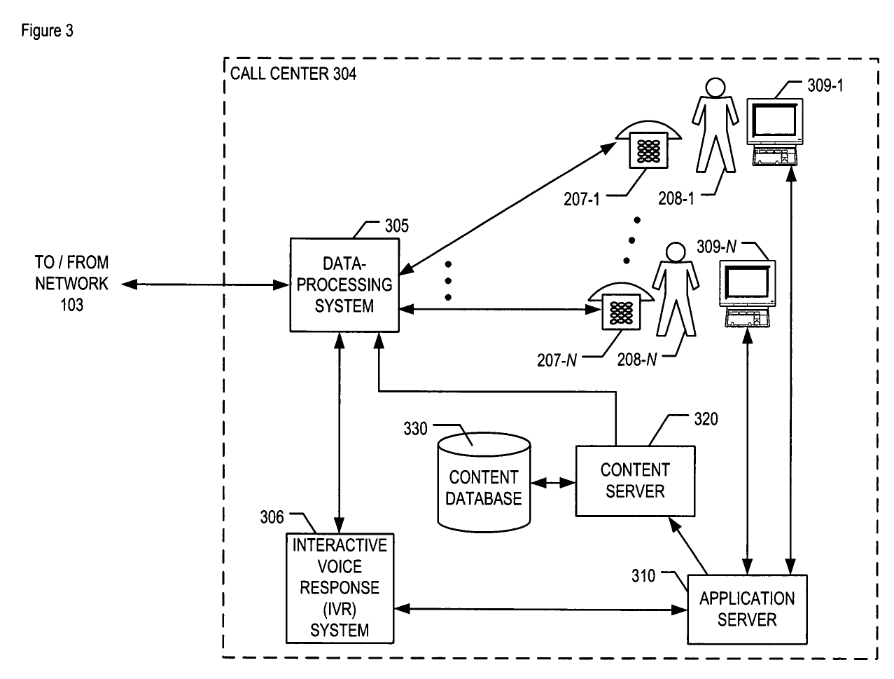

FIG. 3 depicts the salient elements of call center 304, in accordance with the illustrative embodiment of the present invention. Call center 304 comprises data-processing system 305, interactive voice response system (IVR) 306, telecommunications terminals 207-1 through 207-N, where N is a positive integer, clients 309-1 through 309-N, application server 310, content server 320, and content database 330, interconnected as shown.

As shown in FIG. 3, each telecommunications terminal 207-n, for n=1 through N, is associated with a respective service agent 208-n, as in call center 104 of the prior art. Incoming calls are distributed to telecommunications terminals 207 by data-processing system 305, as described below. When an incoming call is routed to telecommunications terminal 207-n, service agent 208-n converses with the caller in well-known fashion and might submit one or more commands (e.g., looking up a billing record associated with the caller, etc.) to a software application via client 309-n (e.g., a personal computer, a “dumb” terminal, etc.) during the call.

Client 309-n presents one or more interfaces to software applications that are hosted on application server 310 (e.g., a browser-based interface for a web application, a rich graphical user interface for a client/server application, etc.), which is described below, in well-known fashion.

Data-processing system 305 is one of a gateway, a private branch exchange (PBX), a router, etc. that is capable of receiving incoming calls from telecommunications network 103 and of directing the calls to interactive voice response (IVR) system 306 or to one of telecommunications terminals 207, depending on how data-processing system 305 is programmed or configured. In some embodiments of the present invention, all incoming calls might initially be routed to interactive voice response system 306, and, when appropriate based on user input to interactive voice response system 306, calls might be forwarded back from interactive voice response system 306 to data-processing system 305 for routing to one of telecommunications terminals 207 for assistance by a service agent 208. In some embodiments data-processing system might comprise logic for routing calls to service agents 208, such as routing an incoming call to a particular service agent based on how busy various service agents have been in a recent time interval, the telephone number called, etc.

Data-processing system 305 is also capable of receiving outbound signals of various types (e.g., audio, video, etc.) from telecommunications terminals 207, interactive voice response (IVR) system 306, and content server 320, and of transmitting the signals on to telecommunications network 103 for delivery to the caller's terminal, in well-known fashion. It will be clear to those skilled in the art how to make and use data-processing system 305.

Interactive voice response system 306 is capable of presenting a menu to the caller and of receiving input from the caller (e.g., speech signals, keypad input, etc.) via data-processing system 305. Interactive voice response system 306 is also capable of forwarding calls to data-processing system 305 for routing to a service agent, as described above. In addition, interactive voice response system 306 is capable of submitting commands and forwarding caller input to a software application that resides on application server 310, of receiving output from the software application (e.g., the result of a query, a new menu to present to the caller, etc.), and of transmitting the output to data-processing system 305 for delivery to the caller. It will be clear to those skilled in the art how to make and use interactive voice response system 306.

Application server 310 is capable of hosting one or more software applications that perform tasks such as customer record maintenance, inventory management, order processing, etc. These software applications can be accessed by clients 309 (e.g., via a browser, via a full-featured graphical user interface, etc.) and by interactive voice response system 306 in well-known fashion.

Content server 320 receives commands from application server 310 for retrieving content with particular properties and streaming the content to a particular user. Content server 320 issues queries to content database 330 to retrieve such content, and then buffers and transmits the content via data-processing system 305 to the user in a streaming fashion, as is well-known in the art. It will be clear to those skilled in the art how to build and use content server 320.

Content database 330 stores a plurality of multimedia content (e.g., video advertisements, instruction manuals, audio announcements, etc.), associates each unit of content with a plurality of properties (e.g., conversation state, terminal bandwidth requirements, mode of communication, suitable user profiles [e.g., suitable age range, suitable income range, etc.], items in inventory, etc.) and enables efficient retrieval of content based on values for these properties. Content database 330 receives queries from content server 320, as described above, and returns content to content server 320 in well-known fashion. It will be clear to those skilled in the art how to build and use content database 330.

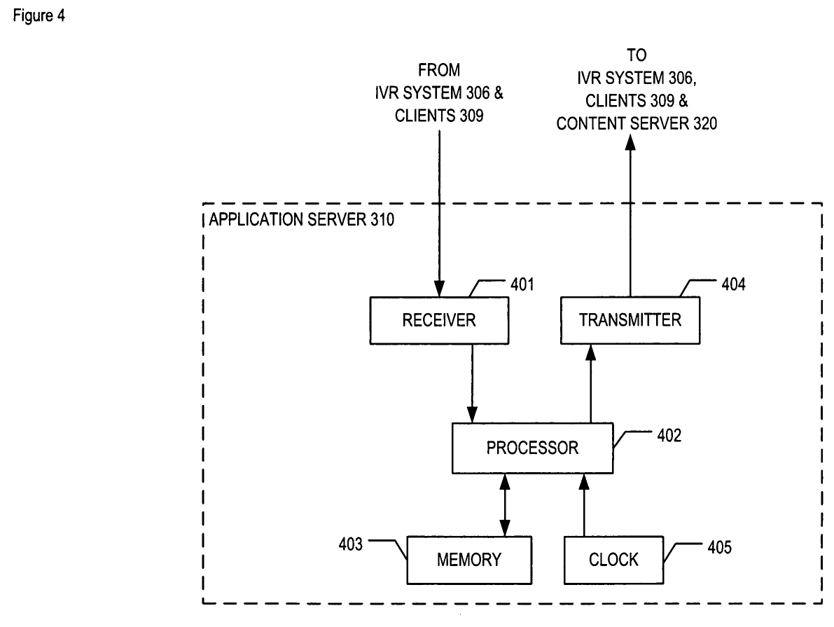

FIG. 4 depicts a block diagram of the salient components of application server 310, in accordance with the illustrative embodiment of the present invention.

As shown in FIG. 4, application server 310 comprises receiver 401, processor 402, memory 403, transmitter 404, and clock 405, interconnected as shown.

Receiver 401 receives signals from clients 309 and interactive voice response system 306 (e.g., queries, commands to update records, etc.) and forwards the information encoded in the signals to processor 402, in well-known fashion. It will be clear to those skilled in the art, after reading this specification, how to make and use receiver 401.

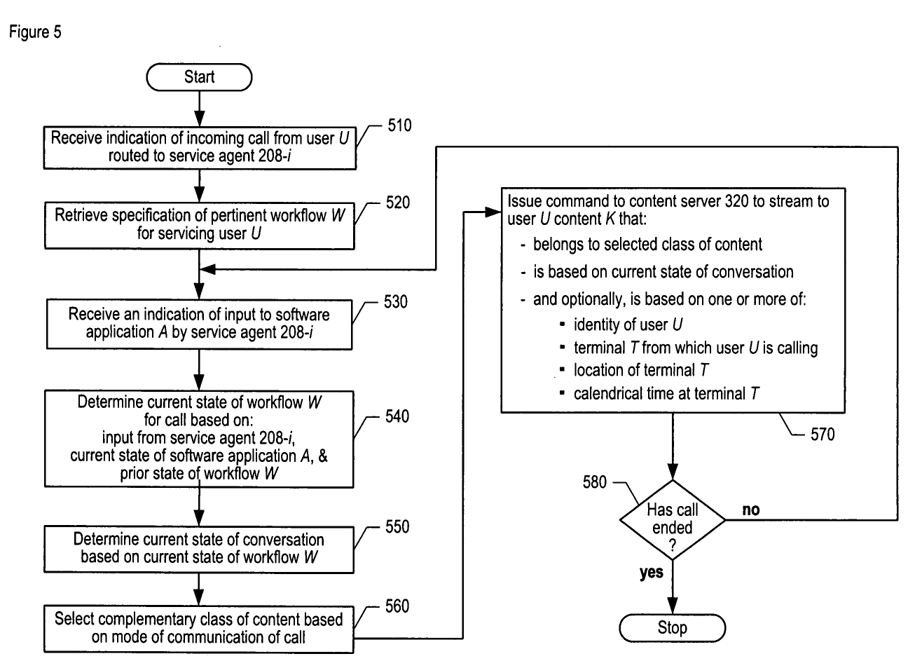

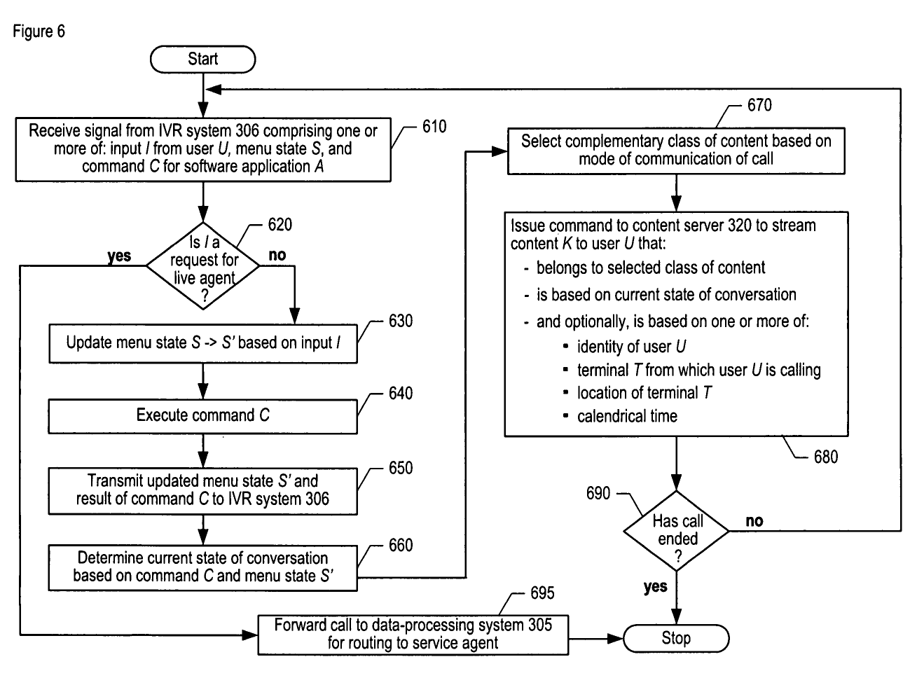

Processor 402 is a general-purpose processor that is capable of receiving information from receiver 401, of executing instructions stored in memory 403, of reading data from and writing data into memory 403, of executing the tasks described below and with respect to FIGS. 5 and 6, and of transmitting information to transmitter 404. In some alternative embodiments of the present invention, processor 402 might be a special-purpose processor. In either case, it will be clear to those skilled in the art, after reading this specification, how to make and use processor 402.

Memory 403 stores data and executable instructions, as is well-known in the art, and might be any combination of random-access memory (RAM), flash memory, disk drive memory, etc. It will be clear to those skilled in the art, after reading this specification, how to make and use memory 403.

Transmitter 404 receives information from processor 402 and transmits signals that encode this information to clients 309, interactive voice response system 306, and content server 320 in well-known fashion. It will be clear to those skilled in the art, after reading this specification, how to make and use transmitter 404.

Clock 405 transmits the current time and date to processor 402 in well-known fashion.

FIG. 5 depicts a flowchart of the salient tasks of application server 310 when an incoming call is handled by a service agent 208-n, in accordance with the illustrative embodiment of the present invention. It will be clear to those skilled in the art which tasks depicted in FIG. 5 can be performed simultaneously or in a different order than that depicted.

At task 510, application server 310 receives an indication of an incoming call from user U routed to service agent 208-n via data-processing system 305.

At task 520, processor 402 of application server 310 retrieves the specification of a pertinent workflow W for servicing user U (e.g., based on the identity of user U, based on previous calls from user U, based on the telephone number that user U called to reach the call center, etc.) from memory 403. The workflow W might be a new workflow for the call, or might be a partially-completed workflow that was started during a previous call.

At task 530, application server 310 receives an indication of input to a software application A by service agent 208-n. Such input might include a query to retrieve data associated with the caller, an indication that a particular task in a script has been performed (e.g., checking a checkbox in a graphical user interface depiction of the script, etc.), and so forth.

At task 540, application server 310 determines the current state of workflow W for the call based on: input from service agent 208-n, the current state of software application A, and the prior state of workflow W.

At task 550, application server 310 determines the current state of the conversation (e.g., order taking, inventory checking, credit card processing, etc.) based on the current state of workflow W.

At task 560, application server 310 selects a class of content (e.g., video, audio, etc.) that is complementary to the mode of communication of the call (e.g., a different class of content, a class of content that will be non-disruptive to the call, etc.), in well-known fashion.

At task 570, application server 310 issues a command to content server 320 to stream to user U content K from content database 330 that (i) belongs to the class of content selected at task 560, and (ii) is based on the current state of the conversation, determined at task 550. In some embodiments, selection of content might also be based on at least one of:
(i) the identity of user U;
(ii) the telecommunications terminal T from which user U is calling call center 304
(iii) the location of terminal T; and
(iv) the calendrical time at terminal T.

At task 580, application server 310 checks whether the call has ended. If so, the method of FIG. 5 terminates; otherwise, execution goes back to task 530 for receiving subsequent inputs from service agent 208-n and potentially delivering new content to user U.

FIG. 6 depicts a flowchart of the salient tasks of application server 310 when an incoming call is handled by interactive voice response system 306, in accordance with the illustrative embodiment of the present invention. It will be clear to those skilled in the art which tasks depicted in FIG. 6 can be performed simultaneously or in a different order than that depicted.

At task 610, application server 310 receives a signal from interactive voice response system 306 that comprises one or more of: input I from user U, the current menu state S (e.g., the current menu, a history of user U's navigation through the menu hierarchy, etc.), and command C for software application A.

At task 620, application server 310 checks whether input I is a request for a service agent. If so, execution proceeds to task 695; otherwise execution continues at task 630.

At task 630, application server 310 updates the menu state S to S′ based on input I.

At task 640, application server 310 executes command C.

At task 650, application server 310 transmits the updated menu state S′ and the result of command C (e.g., a record returned for a query, etc.) to interactive voice response system 306.

At task 660, application server 310 determines the current state of the conversation based on command C and menu state S′.

At task 670, application server 310 selects a class of content that is complementary to the mode of communication of the call, in well-known fashion.

At task 680, application server 310 issues a command to content server 320 to stream to user U content K from content database 330 that (i) belongs to the class of content selected at task 670, and (ii) is based on the current state of the conversation, determined at task 660. In some embodiments, selection of content might also be based on at least one of:
(i) the identity of user U;
(ii) the telecommunications terminal T from which user U is calling call center 304
(iii) the location of terminal T; and
(iv) the calendrical time at terminal T.

At task 690, application server 310 checks whether the call has ended. If so, the method of FIG. 6 terminates; otherwise, execution goes back to task 610 for receiving subsequent inputs from interactive voice response system 306 and potentially delivering new content to user U.

At task 695, application server 310 forwards user U's call to data-processing system 305 for routing to a service agent 208-n. After task 695, the method of FIG. 6 terminates.

Although the illustrative embodiment of the present invention is disclosed in the context of a call center, it will be clear to those skilled in the art after reading this specification how to make and use embodiments of the present invention for other kinds of telecommunications systems (e.g., for a doctor's office with a single receptionist and no interactive voice response system, etc.). Furthermore, although the illustrative embodiment of the present invention employs a client/server computing architecture, it will be clear to those skilled in the art after reading this specification how to make and use embodiments of the present invention for other computing environments (e.g., a doctor's office with a standalone personal computer, etc.).

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising transmitting from a data-processing system a signal to a first telecommunications terminal associated with a first user;
wherein said first user is engaged in a conversation with a second user of a second telecommunications terminal; and
wherein said signal is based on the current state of said conversation; and
wherein the mode of communication represented by said signal is different than the mode of communication of said conversation.

2. The method of claim 1 wherein said second user follows a script, and wherein the current state of said conversation is based on the current point in said script.

3. The method of claim 1 wherein the current state of said conversation is based on a workflow that involves said second user.

4. The method of claim 1 wherein the current state of said conversation is based on one or more inputs from said second user to a software application during said conversation.

5. The method of claim 4 wherein an input from said second user to said software application is for retrieving information associated with said first user.

6. The method of claim 1 wherein said signal is non-disruptive to said first user.

7. The method of claim 1 wherein said signal is also based on the identity of said first user.

8. The method of claim 1 wherein said signal is also based on the calendrical time at said first telecommunications terminal.

9. A method comprising transmitting from a data-processing system a signal to a first telecommunications terminal associated with a first user;
wherein said first user is engaged in a conversation with a second user of a second telecommunications terminal; and
wherein said signal is based on the current state of said conversation; and
wherein said signal is non-disruptive to said first user.

10. The method of claim 9 wherein said second user follows a script, and wherein the current state of said conversation is based on the current point in said script.

11. The method of claim 9 wherein the current state of said conversation is based on a workflow that involves said second user.

12. The method of claim 9 wherein the current state of said conversation is based on one or more inputs from said second user to a software application during said conversation.

13. The method of claim 9 wherein said signal is also based on said first telecommunications terminal.

14. The method of claim 9 wherein said signal is also based on the location of said first telecommunications terminal.

15. A method comprising transmitting from a data-processing system a signal to a first telecommunications terminal associated with a first user;
wherein said first user is engaged in a call with a second user of a second telecommunications terminal; and
wherein said signal is based on the current state of a workflow that involves said second user; and
wherein said signal is not part of said call.

16. The method of claim 15 wherein said workflow comprises a software application, and wherein the current state of said workflow is based on one or more inputs from said second user to said software application during said call.

17. The method of claim 15 wherein said signal is non-disruptive to said first user.

18. The method of claim 15 wherein said second user follows a script, and wherein said signal is also based on the current point in said script for said call.

19. A method comprising transmitting from a data-processing system a signal to a telecommunications terminal;
wherein the user of said telecommunications terminal is engaged in a call that involves an interactive voice response system; and
wherein said signal is not part of said call; and
wherein the mode of communication represented by said signal is different than the mode of communication of said call.

20. The method of claim 19 wherein said signal is based on a navigation history of said user through a menu hierarchy of said interactive voice response system.

21. The method of claim 19 wherein said interactive voice response system transmits a command to a software application based on an input from said user, and wherein said software application selects said signal based on the result of executing said command.
